(19) United States
(12) Patent Application Publication
(10) Pub. No.: US 2024/0326641 A1
(43) Pub. Date: Oct. 3, 2024

(54) QUICK-SWAPPING BRACKET ASSEMBLY WITH HIGH LOCKING STABILITY AND ELECTRIC VEHICLE COMPRISING THE SAME

(71) Applicants: AULTON NEW ENERGY AUTOMOBILE TECHNOLOGY CO., LTD., Guangzhou, Guangdong (CN); SHANGHAI DIANBA NEW ENERGY TECHNOLOGY CO., LTD., Shanghai (CN)

(72) Inventors: Jianping Zhang, Shanghai (CN); Danliang Qiu, Shanghai (CN); Meng Liu, Shanghai (CN); Xinrui Yu, Shanghai (CN)

(21) Appl. No.: 18/575,502

(22) PCT Filed: Nov. 30, 2022
(86) PCT No.: PCT/CN2022/135644

§ 371 Date: Dec. 29, 2023

(30) Foreign Application Priority Data
Nov. 30, 2021 (CN) 202111444383.8
Dec. 26, 2021 (CN) 202111606763.7
Dec. 26, 2021 (CN) 202111606781.5
Dec. 31, 2021 (CN) 202111668034.4

(51) Int. Cl. B60L 53/80; H01M 50/249; H01M 50/262

(52) U.S. Cl. CPC B60L 53/80; H01M 50/249; H01M 50/262; H01M 2220/20

(57) ABSTRACT

A quick-swapping bracket assembly with high locking stability and electric vehicle comprising the same, the quick-swapping bracket assembly comprises a vehicle body bracket and a lock base. The lock base is fixed onto the electric vehicle by means of the vehicle body bracket, the opening of the lock base is arranged at the bottom, and the battery box enters the slideway through the opening at the bottom, so that the battery box is locked in the slideway and avoid the battery box entering the slideway from the side of the lock base, which can avoid the lock shaft being skidded out from one side of the lock base and improve the safety of the battery box being locked.

The present application claims the priority of Chinese patent application CN2021116680344 with a filing date of Dec. 31, 2021, Chinese patent application CN2021116067637 with a filing date of Dec. 26, 2021, Chinese patent application CN2021116067815 with a filing date of Dec. 26, 2021, Chinese patent application CN2021114443838 with a filing date of Nov. 30, 2021. The contents of the Chinese patent applications are incorporated herein by reference in their entireties.

### TECHNICAL FIELD

The invention relates to the field of electric vehicle, especially it relates to a quick-swapping bracket assembly with high locking stability and electric vehicle comprising the same.

### BACKGROUND

The setting methods of the battery box of electric vehicles nowadays are generally divided into fixed type and replaceable type, wherein, the fixed type battery is generally fixed on the vehicle, and the vehicle is directly used as the charging object when charging. While the replaceable type battery box is generally fixed on the bracket of the vehicle by means of movable installation. The battery box can be taken out to proceed replacing or charging for the battery box separately. After the replaced battery box is fully charged, it is reinstalled on the vehicle.

For electric trucks, especially electric heavy trucks, the battery box of electric trucks usually takes the replaceable type. The sides of the battery box have lock shafts, and the electric truck is provided with a lock base, and the lock shaft can be inserted into the lock slot on the lock base from the side of the lock base. The lock shaft presents as a cantilever beam state, and the stress capability of both the lock shaft and the lock base is poor, but the battery pack of the electric truck is heavy in weight, which causes the lock shaft is easy to slide away from the lock base, and even worse, the lock shaft may slide and fall down from the side of the lock base.

### CONTENT OF THE PRESENT INVENTION

The technical problem to be solved by the present invention is to overcome the above defects of the prior arts that the battery box of an electric vehicle is locked in the lock base by a lock shaft in a cantilever state to cause a poor stress condition, and provide a quick-swapping bracket assembly with high locking stability and an electric vehicle comprising the same.

The present invention solves the technical problem by the following technical solutions:

A quick-swapping bracket assembly with high locking stability, used for locking the battery box to an electric vehicle, the quick-swapping bracket assembly comprises a vehicle body bracket and a lock base, the vehicle body bracket is fixed onto the electric vehicle; the lock base is arranged under the vehicle body bracket, an opening and a slideway extending from the opening are arranged under the lock base, and the opening is used for the lock shaft on the battery box entering and exiting the slideway, and both the opening and the slideway pass through the lock base along the axial direction of the lock shaft.

In this solution, the lock base is fixed onto the electric vehicle by means of the vehicle body bracket, the opening of the lock base is arranged at the bottom, and the battery box enters the slideway through the opening at the bottom, so that the battery box is locked in the slideway and avoid the battery box entering the slideway from the side of the lock base, which can avoid the lock shaft being skidded out from one side of the lock base and improve the safety of the battery box being locked.

Preferably, both ends of the lock shaft are exposed from the slideway, and both ends of the lock shaft are connected with the battery box.

In this solution, both ends of the lock shaft are connected with the battery box, so that the middle part of the lock shaft is stuck in the slideway, then the two ends of the lock shaft bear the load of the battery box, thereby improving the uniformity of the load applied on the lock shaft, and avoiding the lock shaft being skidded out from one side of the lock base, which can improve the safety of the battery box being locked.

Preferably, the vehicle body bracket comprises a longitudinal beam, and the longitudinal beam extending along the length direction of the electric vehicle, the longitudinal beam is fixed onto the vehicle beam of the electric vehicle, and the lock base is arranged at the bottom of the longitudinal beam.

In this solution, the vehicle body bracket comprises the longitudinal beam, which makes the structure simple, and is convenient to adapt to the structure of the electric vehicle.

Preferably, the longitudinal beam comprises a top plate, a side plate and a bottom plate being connected with sequentially, the side plate is fixedly connected with the vehicle beam, the top plate and the bottom plate respectively extends outward from both sides of the side plate along the axial direction of the lock shaft, and the lock base is arranged on the bottom plate.

In this solution, the longitudinal beam comprises a top plate, a side plate and a bottom plate being connected with sequentially, which makes the structure simple, and has a high stability.

Preferably, the bottom plate is provided with an insert slot, and the lock base is inserted into the insert slot from top to bottom.

In this solution, the lock base is inserted into the insert slot from top to bottom, which is convenient for installation.

Preferably, the lock base comprises a base body and a mounting edge, and the mounting edge extends outward around the base body, and the lower side of the base body is provided with the opening and the slideway, the base body is inserted into the insert slot, and the mounting edge is wedged on the bottom plate.

In this solution, the base body is inserted into the insert slot, which makes it's convenient for the battery box being locked to the lock base from top to bottom. The mounting edge is wedged on the bottom plate, which can simplify the connection between the lock base and the longitudinal beam, and improve the stability of the connection, and prevent the lock base falling off from the longitudinal beam.

Preferably, the longitudinal beam further comprises a folded plate, the folded plate extends upward from the edge of the bottom plate, and there is a space between the top surface of the folded plate and the top plate, and a containing space is formed between the folded plate and the side plate, and the lock base is arranged in the containing space by means of the space.

In this solution, the folded plate can further improve the strength of the longitudinal beam, and the containing space can provide a relatively stable installation and application environment for the lock base and reduce the impurity entering.

Preferably, the top plate, the side plate, the bottom plate and the folded plate are an integral structure;

or, the top plate, the side plate, the bottom plate and the edge plate are spliced connection sequentially.

In this solution, the longitudinal beam as an integral structure has a high strength, and is convenient to manufacture. The longitudinal beam as spliced connection sequentially makes the structure simple.

Preferably, the quick-swapping bracket assembly further comprises a plurality of reinforcement plates, and the reinforcement plates are wedged between the top plate and the bottom plate, the side edge of the reinforcement plate is connected to the side plate.

In this solution, the reinforcement plate can further improve the strength of the longitudinal beam.

Preferably, a mounting flange is arranged on the side wall of the longitudinal beam, and the lock base is arranged on the bottom of the mounting flange.

In this solution, the lock base is arranged on the mounting flange, which makes the structure simple, preferably, the mounting flange is formed by extending outward from the side wall of the longitudinal beam, which can fully utilize the installation space outside the vehicle beam.

Preferably, the quick-swapping bracket assembly further comprises an upright column and a crossbeam, the longitudinal beam is connected with the crossbeam by means of the upright column, and the longitudinal beam, the upright column and the crossbeam are sequentially connected to form a rectangular frame.

In this solution, the quick-swapping bracket assembly with the shape of rectangular frame makes the structure simple, and is convenient to adapt to the electric vehicle.

Preferably, the bottom surface of the longitudinal beam is higher than the top surface of the crossbeam.

In this solution, it is convenient to contain the battery box, and it can improve the height of the battery box and avoid the interference between the battery box and other parts of the electric vehicle. Furtherly, it can avoid the interference between the crossbeam and the vehicle beam.

Preferably, both the longitudinal beam and the crossbeam are provided with lightening holes.

In this solution, the lightening holes are convenient for reducing the weight of the longitudinal beam and the crossbeam itself, which is beneficial to improving the navigating endurance of the electric vehicle.

Preferably, a reinforcement piece is provided between the longitudinal beam and the upright column.

In this solution, the reinforcement piece can improve the strength and stability between the longitudinal beam and the upright column.

Preferably, the quick-swapping bracket assembly further comprises an electrical connector, and the electrical connector is arranged at the middle of the crossbeam.

In this solution, it is convenient for the electrical connection between the battery box and the electric vehicle.

Preferably, a guide part is arranged at the lower end of the lock base, and the cross-section of the guide part becomes larger along the direction of the lock shaft entering the opening.

In this solution, the guide part is convenient for the positioning of the lock shaft and the lock base of the battery box, and is convenient for entering the opening and the slideway.

Preferably, a containing slot is arranged on the top of the lock base, and the containing slot is communicated with the slideway, the quick-swapping bracket assembly further comprises:
a lock tongue, the lock tongue is pivotally arranged on the lock base, and the lock tongue can swing in the containing slot and the slideway to communicate or block the slideway;
a lock linkage, the lock linkage acts on the lock tongue, and the lock linkage is used to drive the lock tongue to swing.

In this solution, the lock tongue is arranged in the containing slot, which makes the structure compact and easy to operate. The lock tongue can lock the battery box in the slideway, and the lock linkage is convenient for applying force on the lock tongue and synchronously controlling a plurality of lock tongues.

Preferably, the quick-swapping bracket assembly further comprises: a reset piece, one end of the reset piece is connected with one end part of the lock linkage, and the other end of the reset piece is connected with the vehicle body bracket.

In this solution, the reset piece applies force on the lock tongue by means of the lock linkage, to make the lock tongue is at a locking condition, which can avoid the lock tongue mistakenly unlocking, and improve the safety of the battery box being locked.

Preferably, the quick-swapping bracket assembly further comprises a buffer part, at least a part of the buffer part is located in the slideway, when the lock shaft is at the locking point in the slideway, the buffer part abuts against the lock shaft.

In this solution, by utilizing the buffer part to absorb part of the motion energy of the lock shaft when it is switched to the locking condition, it can reduce the impact of the lock shaft to the lock base, reduce noise when the lock base is locked, and improve the stability of the lock shaft in the locking condition.

An electric vehicle, wherein it comprises a battery box and the quick-swapping bracket assembly as described above, the battery box is arranged on the quick-swapping bracket assembly.

In this solution, the battery box of the electric vehicle is locked by the quick-swapping bracket assembly, which can avoid the lock shaft being skidded out from one side of the lock base, and improve the safety of the battery box being locked.

On the basis of conforming to common knowledge in the art, the above-mentioned preferable conditions can be combined randomly to obtain preferred examples of the present invention.

The positive and progressive effects of the present invention are:

In this invention, the lock base is fixed onto the electric vehicle by means of the vehicle body bracket, the opening of the lock base is arranged at the bottom, and the battery box enters the slideway by the opening at the bottom, so that the battery box is locked in the slideway, which avoid that the battery box enters the lock base from the side of the slideway, and avoid the lock shaft being skidded out from one side of the lock base, and improve the safety of the battery box being locked.

### BRIEF DESCRIPTION OF THE DRAWINGS

FIG. 1 is a schematic structural diagram of a quick-swapping bracket assembly in a preferred embodiment of the present invention.

FIG. 2 is a schematic side view of the quick-swapping bracket assembly in FIG. 1.

FIG. 3 is a partially enlarged structural schematic diagram of the quick-swapping bracket assembly in FIG. 2.

FIG. 4 is a schematic structural view of the longitudinal beam in the quick-swapping bracket assembly of FIG. 1.

FIG. 5 is a schematic structural view of the lock base in the quick-swapping bracket assembly of FIG. 1.

FIG. 6 is a structural schematic diagram of a reinforcement plate in the quick-swapping bracket assembly of FIG. 1.

FIG. 7 is a schematic structural view of an electric vehicle comprising the quick-swapping bracket assembly in FIG. 1.

### REFERENCE NUMERALS

quick-swapping bracket assembly 100
reinforcement plate 11
U-shaped plate 111
external roll-over plate 112
upright column 12
crossbeam 13
lightening hole 14
reinforcement piece 15
electrical connector 16
vehicle body bracket 20
longitudinal beam 21
top plate 22
side plate 23
bottom plate 24
insert slot 25
folded plate 26
lock base 30
opening 31
slideway 32
base body 33
mounting edge 34
guide part 35
containing slot 36
lock tongue 37
lock linkage 38
reset piece 39
buffer part 40
electric vehicle 500
battery box 51
vehicle beam 52

### DETAILED DESCRIPTION OF THE PREFERRED EMBODIMENT

The following embodiments further illustrate the present disclosure, but the present disclosure is not limited by the following embodiments thereto.

As shown in FIGS. 1-7, the present embodiment comprises a quick-swapping bracket assembly 100 with high locking stability and an electric vehicle 500 comprising the battery box and the quick-swapping bracket assembly 100, and the quick-swapping bracket assembly 100 is used for locking the battery box 51 to the electric vehicle 500, the quick-swapping bracket assembly 100 comprises a vehicle body bracket 20 and a lock base 30, the vehicle body bracket 20 is fixed onto the electric vehicle 500; the lock base 30 is arranged under the vehicle body bracket 20, an opening 31 and a slideway 32 extending from the opening 31 are arranged under the lock base 30, and the opening 31 is used for the lock shaft on the battery box 51 entering and exiting the slideway 32, and both the opening 31 and the slideway 32 pass through the lock base 30 along the axial direction of the lock shaft. The lock base 30 is fixed onto the electric vehicle 500 by means of the vehicle body bracket 20, the opening 31 of the lock base 30 is arranged at the bottom, and the battery box 51 enters the slideway 32 through the opening at the bottom, so that the battery box 51 is locked in the slideway 32, and avoid the battery box 51 entering the slideway 32 from the side of the lock base 30, which can avoid the lock shaft being skidded out from one side of the lock base 30, and improve the safety of the battery box 51 being locked.

Both ends of the lock shaft are exposed from the slideway 32, and both ends of the lock shaft are connected with the battery box 51. Both ends of the lock shaft are connected with the battery box 51, so that the middle part of the lock shaft is stuck in the slideway 32, and the two ends of the lock shaft bear the load of the battery box 51, thereby improving the uniformity of the load on the lock shaft, and avoiding that the lock shaft being skidded out from one side of the lock base 30, which can improve the safety of the battery box 51 being locked.

As shown in FIG. 1, the vehicle body bracket 20 comprises a longitudinal beam 21, and the longitudinal beam 21 extending along the length direction of the electric vehicle 500, the longitudinal beam 21 is fixed onto the vehicle beam 52 of the electric vehicle 500, and the lock base 30 is arranged at the bottom of the longitudinal beam 21. The vehicle body bracket 20 comprises the longitudinal beam 21, which makes the structure simple, and is convenient to adapt to the structure of the electric vehicle 500. In other embodiments, the structure pattern of the vehicle body bracket 20 can also be other pattern.

As shown in FIG. 4, the longitudinal beam 21 comprises a top plate 22, a side plate 23 and a bottom plate 24 being connected with sequentially, the side plate 23 is fixedly connected with the vehicle beam 52, the top plate 22 and the bottom plate 24 respectively extends outward from both sides of the side plate 23 along the axial direction of the lock shaft, and the lock base 30 is arranged on the bottom plate 24. The longitudinal beam comprises a top plate 22, a side plate 23 and a bottom plate 24 being connected with sequentially, which makes the structure simple, and has a high stability.

The longitudinal beam 21 further comprises a folded plate 26, the folded plate 26 extends upward from the edge of the bottom plate 24, and there is a space between the top surface of the folded plate 26 and the top plate 22, and a containing space is formed between the folded plate 26 and the side plate 23, and the lock base 30 is arranged in the containing space by means of the space. The folded plate 26 can further improves the strength of the longitudinal beam 21, and the containing space can provide a relatively stable installation and application environment for the lock base 30, and reduce the impurity entering.

As an embodiment, the top plate 22, the side plate 23, the bottom plate 24 and the folded plate 26 are an integral structure; the longitudinal beam 21 as an integral structure has a high strength, and is convenient to manufacture. In other embodiments, the top plate 22, the side plate 23, the bottom plate 24 and the edge plate 26 are spliced connection sequentially. The longitudinal beam as spliced connection sequentially makes the structure simple.

The bottom plate 24 is provided with an insert slot 25, and the lock base 30 is inserted into the insert slot 25 from top to bottom. The lock base 30 is inserted into the insert slot 25 from top to bottom, which is convenient for installation. In this embodiment, the insert slot 25 is a rectangular slot, in other embodiments, the insert slot 25 can also be specifically configured as other structural patterns combining with the shape of the lock base 30.

The lock base 30 comprises a base body 33 and a mounting edge 34, and the mounting edge 34 extends outward around the base body 33, and the lower side of the base body 33 is provided with the opening 31 and the slideway 32, the base body 33 is inserted into the insert slot 25, and the mounting edge 34 is wedged on the bottom plate. The base body 33 is inserted into the insert slot 25, which makes it's convenient for the battery box 51 being locked to the lock base 30 from top to bottom. The mounting edge 34 is wedged on the bottom plate 24, which can simplify the connection between the lock base 30 and the longitudinal beam 21, and improve the stability of the connection, and prevent the lock base 30 falling off from the longitudinal beam 21.

In other embodiments, a mounting flange is arranged on the side wall of the longitudinal beam 21, and the lock base 30 is arranged on the bottom of the mounting flange.

In this solution, the lock base 30 is arranged on the mounting flange, which makes the structure simple, preferably, the mounting flange is formed by extending outward from the side wall of the longitudinal beam 21, which can fully utilize the installation space outside the vehicle beam 52.

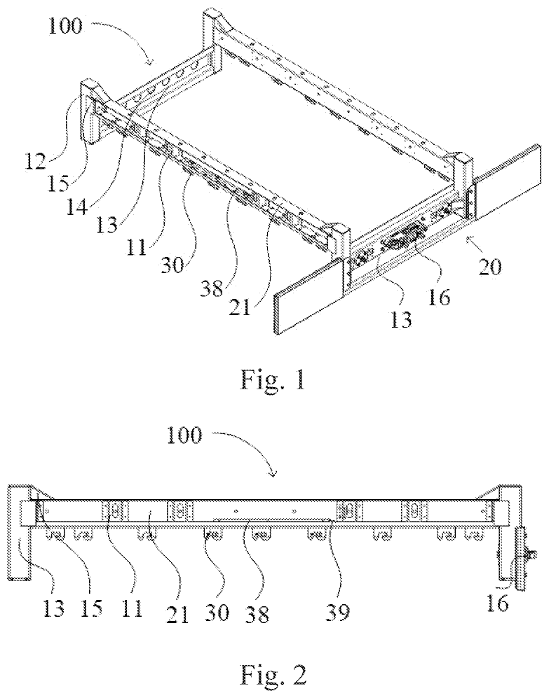

As shown in FIGS. 2-6, the quick-swapping bracket assembly 100 further comprises a plurality of reinforcement plates 11, and the reinforcement plates 11 are wedged between the top plate 22 and the bottom plate 24, the side edge of the reinforcement plate 11 is connected to the side plate 23. The reinforcement plate 11 can further improve the strength of the longitudinal beam 21.

As an embodiment, the reinforcement plate 11 comprises the U-shaped plate 111 and two external roll-over plates 112, the two external roll-over plates 112 respectively extend outward from the open mouth of the U-shaped plate 111, the U-shaped plate 111 and the external roll-over plates 112 are both wedged between the top plate 22 and the bottom plate 24, and the external roll-over plates 112 are connected with the side plate 23. The reinforcement plate 11 including the U-shaped plate 111 and the two external roll-over plates 112, makes the structure simple, has a high strength, and is convenient to connect with the longitudinal beam 21. The reinforcement plate 11 is provided with lightening holes 14 at the side away from the side plate 23. Lightening holes 14 can reduce the weight of the reinforcement plate 11. In other embodiments, the reinforcement plate 11 can also be other structure pattern.

The quick-swapping bracket assembly 100 further comprises an upright column 12 and a crossbeam 13, the longitudinal beam 21 is connected with the crossbeam 13 by means of the upright column 12, and the longitudinal beam 21, the upright column 12 and the crossbeam 13 are sequentially connected to form a rectangular frame. The quick-swapping bracket assembly 100 with the shape of rectangular frame makes the structure simple, and is convenient to adapt to the electric vehicle 500.

The bottom surface of the longitudinal beam 21 is higher than the top surface of the crossbeam 13. It is convenient to contain the battery box 51, and it can improve the height of the battery box 51 and avoid the interference between the battery box 51 and other parts of the electric vehicle 500. Furtherly, it can avoid the interference between the crossbeam 13 and the vehicle beam 52.

Both the longitudinal beam 21 and the crossbeam 13 are provided with lightening holes 14. The lightening holes 14 are convenient for reducing the weight of the longitudinal beam 12 and the crossbeam 13 itself, which is beneficial to improving the navigating endurance of the electric vehicle 500. The lightening hole 14 can be a circle hole, a rectangular hole, etc.

A reinforcement piece 15 is provided between the longitudinal beam 21 and the upright column 12. The reinforcement piece 15 can improve the strength and stability between the longitudinal beam 21 and the upright column 12.

Preferably, the quick-swapping bracket assembly 100 further comprises an electrical connector 16, and the electrical connector 16 is arranged at the middle of the crossbeam 13. It is convenient for the electrical connection between the battery box 51 and the electric vehicle 500.

In this disclosure, as shown in FIG. 1, the upright column 12 are rectangular upright column 12, four upright columns 12 are arranged at four corners respectively, and two longitudinal beams 21 are oppositely arranged and stuck between the two upright columns 12. The two crossbeams 13 are oppositely arranged. The reinforcement piece 15 may be a tetrahedral structure specifically, the side of the reinforcement piece 15 presents triangular shape, and the four reinforcement pieces 15 are arranged at the interface between the upright column 12 and the longitudinal beam 21. One surface of the reinforcement piece 15 as a triangular shape fits with the side surface of the upright column 12, and the other surface of the reinforcement piece 15 as a triangular shape fits with the top surface of the longitudinal beam 21.

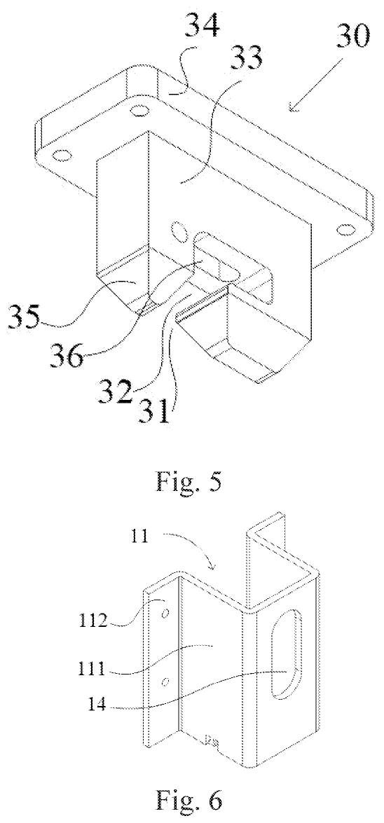

As shown in FIG. 5, a guide part 35 is arranged at the lower end of the lock base 30, and the cross-section of the guide part 35 becomes larger along the direction of the lock shaft entering the opening. The guide part 35 is convenient for the positioning of the lock shaft and the lock base 30 of the battery box 51, and is convenient for entering the opening 31 and the slideway 32. Specifically, the guide part 35 can be a guiding slope.

A containing slot 36 is arranged on the top of the lock base 30, and the containing slot 36 is communicated with the slideway 32, the quick-swapping bracket assembly 100 further comprises a lock tongue 37 and a lock linkage 38, the lock tongue 37 is pivotally arranged on the lock base 30, and the lock tongue 37 can swing in the containing slot 36 and the slideway 32 to communicate or block the slideway 32; the lock linkage 38 acts on the lock tongue 37, and the lock linkage 38 is used to drive the lock tongue 37 to swing. The lock tongue 37 is arranged in the containing slot 36, which makes the structure compact and easy to operate. The lock tongue 37 can lock the battery box 51 in the slideway 32, and the lock linkage 38 is convenient for applying force on the lock tongue 37 and synchronously controlling a plurality of lock tongues 37. The lock linkage 38 moves left or right under the action of external force, so as to drive the lock tongue 37 to pivotally rotate, and the lock tongue 37 after being rotated leaves and enters the slideway 32, thereby realizing unlocking or locking of the lock shaft of the battery box 51.

The quick-swapping bracket assembly 100 further comprises a reset piece 39, one end of the reset piece 39 is connected with one end part of the lock linkage 38, and the other end of the reset piece 39 is connected with the vehicle body bracket 20. The reset piece 39 applies force on the lock tongue 38 by means of the lock linkage 37, to make the lock tongue 37 is at a locking condition, which can avoid the lock tongue 37 mistakenly unlocking, and improve the safety of he battery box 51 being locked. In this embodiment, the reset piece 39 specifically can be spring, one end of the spring is arranged on the longitudinal beam 21, and the other end of the spring is connected to the end part of the lock linkage 38, the spring applies a pulling force on the lock linkage 38.

The quick-swapping bracket assembly 100 further comprises a buffer part 40, at least a part of the buffer part 40 is located in the slideway 32, when the lock shaft is at the locking point in the slideway 32, the buffer part 40 abuts against the lock shaft. By utilizing the buffer part 40 to absorb part of the motion energy of the lock shaft when it is switched to the locking condition, it can reduce the impact of the lock shaft to the lock base 30, reduce noise when the lock base is locked, and improve the stability of the lock shaft in the locking condition. Specifically, the buffer part 40 can be made of materials such as rubber, silica gel, etc.

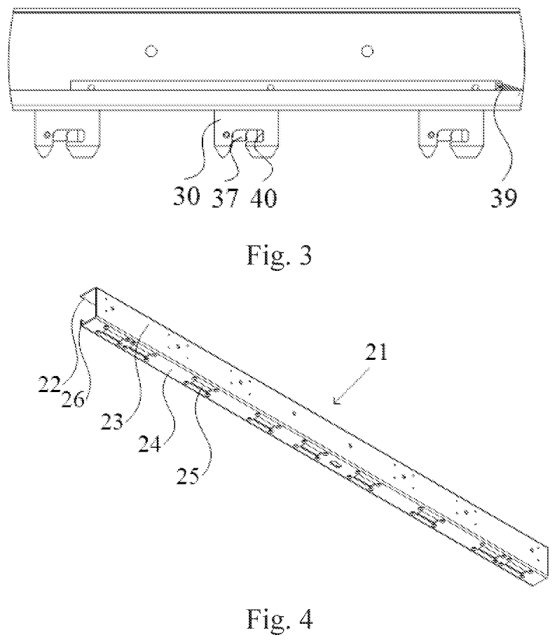

In this embodiment, the lock shaft of the battery box 51 enters the opening 31 from bottom to top, the upper side of the lock shaft can push the lock tongue 37 to pivotally rotate, and the lock tongue 37 after being rotated leaves the slideway 32, then the lock shaft can continue to enter the slideway 32. When the lock shaft is about to reach the end of the slideway 32, the buffer part 40 abuts against the lock shaft. When the lock shaft reaches the locking point, under the drive of gravity and the lock linkage 38, the lock tongue 37 enters the slideway 32, and the side of the lock tongue 37 abuts against the lock shaft, thereby realizing the locking of the lock shaft. As shown in FIG. 3, the reset piece 39 applies a pulling force on the lock linkage 38 to drive the lock linkage 38 to generate a trend of moving to the right, and the lock linkage 38 drives the lock tongue 37 to generate a trend of rotating clockwise, so that it can ensure that the lock tongue 37 enters the slideway 32 to avoid mistakenly unlocking.

As shown in FIG. 3, under the action of external force, the lock linkage 38 can move to the left, the lock linkage 38 drives the lock tongue 37 to rotate counterclockwise, then the rotated lock tongue 37 leaves the slideway 32, so that the lock shaft of the battery box 51 realizes unlocking, and the lock shaft of the battery box 51 can leave the slideway 32 and then leave the lock base 30 from the opening 31.

Using the technical solution in the above-mentioned embodiment, it can fully utilize the height space under the longitudinal beam 21, when the battery swapping device uninstalls the battery box 51, the empty battery swapping device can directly enter the space under the battery box 51, and does not interfere with the bottom of the electric vehicle 500; when the battery swapping device installs the battery box 51, the battery swapping device carrying the battery box 51 and the battery pack can also directly enter the bottom of the longitudinal beam 21 for swapping battery, and does not interfere with the bottom of the electric vehicle 500. During the whole process, there is no need to lift the vehicle body, and also no need to provide a sunken space or dig a pit for the battery swapping device entering or exiting, which reduces the cost, time and difficulty of building a battery swapping station, reduces the requirements for the building field, and improves the battery swapping efficiency.

The quick-swapping bracket assembly 100 of this embodiment is especially suitable for commercial vehicles such as heavy truck and light truck.

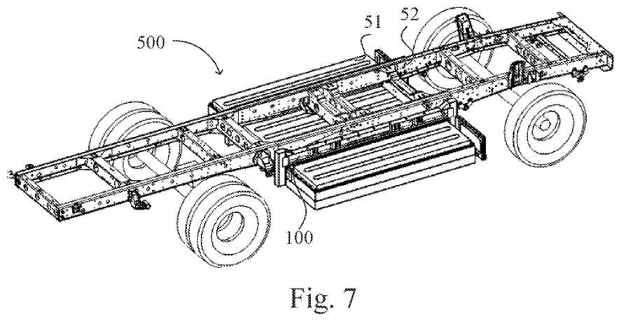

As shown in FIG. 7, this embodiment also discloses an electric vehicle 500, wherein it comprises a battery box 51 and the quick-swapping bracket assembly 100 as described above, the battery box is arranged on the quick-swapping bracket assembly. The battery box 51 of the electric vehicle 500 is locked by the quick-swapping bracket assembly 100, which can avoid the lock shaft of the battery box 51 being skidded out from one side of the lock base 30, and can improve the safety of the battery box 51 being locked. In this embodiment, the electric vehicle 500 can be a commercial vehicle such as a heavy truck or a light truck. In FIG. 7, it only shows the battery box 51, the vehicle beam 52, the quick-swapping bracket assembly 100, the wheel assembly, etc. of the electric vehicle 500 are shown, but not show other assemblies of the electric vehicle 500. The quick-swapping bracket assembly 100 is arranged on the vehicle beam 52 along the length direction of the electric vehicle 500. The battery box 51 is locked by means of the quick-swapping bracket assembly 100.

Although the specific embodiments of the present invention are described above, it should be understood by those skilled in the art that, this is only an example, and without departing from the principle and essence of the present invention, those skilled in the art can make various changes or modifications to these embodiments. So, the scope of protection of the present invention is defined by the appended claims.

1. A quick-swapping bracket assembly with high locking stability, used for locking the battery box onto an electric vehicle, wherein, the quick-swapping bracket assembly comprises:
a vehicle body bracket, and the vehicle body bracket is fixed onto the electric vehicle;
a lock base, and the lock base is arranged under the vehicle body bracket, an opening and a slideway extending from the opening are arranged under the lock base, and the opening is used for the lock shaft on the battery box entering and exiting the slideway, and both the opening and the slideway pass through the lock base along the axial direction of the lock shaft.

2. The quick-swapping bracket assembly as claimed in claim 1, wherein, both ends of the lock shaft are exposed from the slideway, and both ends of the lock shaft are connected with the battery box.

3. The quick-swapping bracket assembly as claimed in claim 1, wherein, the vehicle body bracket comprises a longitudinal beam, and the longitudinal beam extends along the length direction of the electric vehicle, the longitudinal beam is fixed onto the vehicle beam of the electric vehicle, and the lock base is arranged at the bottom of the longitudinal beam.

4. The quick-swapping bracket assembly as claimed in claim 3, wherein, the longitudinal beam comprises a top plate, a side plate and a bottom plate being connected with sequentially, the side plate is fixedly connected with the vehicle beam, the top plate and the bottom plate respectively extends outward from both sides of the side plate along the axial direction of the lock shaft, and the lock base is arranged on the bottom plate.

5. The quick-swapping bracket assembly as claimed in claim 4, wherein, the bottom plate is provided with an insert slot, and the lock base is inserted into the insert slot from top to bottom.

6. The quick-swapping bracket assembly as claimed in claim 5, wherein, the lock base comprises a base body and a mounting edge, and the mounting edge extends outward around the base body, and the lower side of the base body is provided with the opening and the slideway, the base body is inserted into the insert slot, and the mounting edge is wedged on the bottom plate.

7. The quick-swapping bracket assembly as claimed in claim 4, wherein, the longitudinal beam further comprises a folded plate, the folded plate extends upward from the edge of the bottom plate, and there is a space between the top surface of the folded plate and the top plate, and a containing space is formed between the folded plate and the side plate, and the lock base is arranged in the containing space by means of the space.

8. The quick-swapping bracket assembly as claimed in claim 7, wherein, the top plate, the side plate, the bottom plate and the folded plate are an integral structure;
or, the top plate, the side plate, the bottom plate and the edge plate are spliced connection sequentially.

9. The quick-swapping bracket assembly as claimed in claim 4, wherein, the quick-swapping bracket assembly further comprises a plurality of reinforcement plates, and the reinforcement plates are wedged between the top plate and the bottom plate, the side edge of the reinforcement plate is connected with the side plate.

10. The quick-swapping bracket assembly as claimed in claim 3, wherein, a mounting flange is arranged on the side wall of the longitudinal beam, and the lock base is arranged on the bottom of the mounting flange.

11. The quick-swapping bracket assembly as claimed in claim 3, wherein, the quick-swapping bracket assembly further comprises an upright column and a crossbeam, the longitudinal beam is connected with the crossbeam by means of the upright column, and the longitudinal beam, the upright column and the crossbeam are sequentially connected to form a rectangular frame.

12. The quick-swapping bracket assembly as claimed in claim 11, wherein, the bottom surface of the longitudinal beam is higher than the top surface of the crossbeam;
or, both the longitudinal beam and the crossbeam are provided with lightening holes;
or, a reinforcement piece is provided between the longitudinal beam and the upright column;
or, the quick-swapping bracket assembly further comprises an electrical connector, and the electrical connector is arranged at the middle of the crossbeam.

13. The quick-swapping bracket assembly as claimed in claim 1, wherein, a guide part is arranged at the lower end of the lock base, and the cross-section of the guide part becomes larger along the direction of the lock shaft entering the opening.

14. The quick-swapping bracket assembly as claimed in claim 1, wherein, a containing slot is arranged on the top of the lock base, and the containing slot is communicated with the slideway, the quick-swapping bracket assembly further comprises:
a lock tongue, the lock tongue is pivotally arranged on the lock base, and the lock tongue can swing in the containing slot and the slideway to communicate or block the slideway;
a lock linkage, the lock linkage acts on the lock tongue, and the lock linkage is used to drive the lock tongue to swing.

15. The quick-swapping bracket assembly as claimed in claim 14, wherein, the quick-swapping bracket assembly further comprises: a reset piece, one end of the reset piece is connected with one end part of the lock linkage, and the other end of the reset piece is connected with the vehicle body bracket.

16. The quick-swapping bracket assembly as claimed in claim 1, wherein, the quick-swapping bracket assembly further comprises a buffer part, at least a part of the buffer part is located in the slideway, when the lock shaft is at the locking point in the slideway, the buffer part abuts against the lock shaft.

17. An electric vehicle, wherein, the electric vehicle comprises a battery box and the quick-swapping bracket assembly as claimed in claim 1, the battery box is arranged on the quick-swapping bracket assembly.
